(19) United States
(12) Patent Application Publication
(10) Pub. No.: US 2011/0167761 A1
(43) Pub. Date: Jul. 14, 2011

(54) Low Inertia Capping Clutch

(76) Inventors: VIJAY K. JHA, OAKBROOK, IL (US); MARK MILAZZO, EVANSTON, IL (US)

(21) Appl. No.: 12/836,463

(22) Filed: Jul. 14, 2010

Related U.S. Application Data
(60) Provisional application No. 61/225,408, filed on Jul. 14, 2009.

(51) Int. Cl. B67B 3/20

(52) U.S. Cl. 53/317; 53/331.5

(57) ABSTRACT

A low inertia capping clutch has an outer driving portion and an inner driven portion coupled together by a magnetic interaction. Cavities within the driven inner portion of the clutch reduce the mass and therefore reduce residual rotational inertia. This residual rotational inertia is further reduced by forming the driven inner portion of the clutch out of lightweight material.

This application claims the benefit of U.S. Provisional Application No. 61/225,408 filed Jul. 14, 2009.

### FIELD OF THE INVENTION

This invention relates to magnetic clutches, particularly magnetic clutches that are used in engaging the top closures with containers, particularly attaching bottle caps to bottles.

### BACKGROUND OF THE INVENTION

The top of a typical bottle neck is often screw threaded so that a correspondingly screw threaded cap can be screwed onto the cap in order to close the bottle.

In a typical bottling process, caps are screwed onto the bottles after the bottles are filled with a liquid. This entire process is typically automated. A bottle capping machine is used to screw on the caps. In order to rapidly screw on bottle caps without over-torquing or over-tightening the cap onto the bottle, a magnetic clutch is utilized between the bottle cap and the capping machine.

In a magnetic clutch, torque is transferred from an input end, through a magnetic coupling, and to an output end. Magnetic capping clutches are disclosed in U.S. Provisional Application 61/102,243 filed on Oct. 2, 2008, herein incorporated by reference. Capping clutches are typically designed to have a maximum torque. That is, the magnetic interaction allows torque to be transmitted through the clutch from input end to output end until a maximum torque is reached and after that there is relative rotational slipping between the input end and the output end of the magnetic clutch. This torque can be adjusted by axially positioning the magnets to be less or more in alignment.

Though the selected attraction force between the magnet rings allows for the limited application of torque, the bottle cap may still become tightened more than desired. This is because when the magnet rings become magnetically de-coupled, although the inner driven portion is no longer being driven by the outer body portion, the inner driven portion has a built up or residual rotational inertia that will further tighten the cap onto the bottle. This residual rotational inertia can cause over-tightening of the cap onto the bottle.

An over-tightened bottle cap may require an undesirable increased effort by the end user to unscrew the bottle cap.

The present inventors have recognized the need for a magnetic capping clutch, of which the applied torque may be more precisely controlled.

Accordingly, the present inventors have recognized the need for a magnetic capping clutch that reduces the torque effect caused by the rotational inertia of the capping clutch.

### SUMMARY OF THE INVENTION

The present invention comprises a low inertia capping clutch. This clutch includes attachments for attaching to different drive configurations and different bottle caps. The clutch body contains an outer body portion and an inner driven portion. A driving mechanism of the capping machine is attached to the outer body portion to rotate the outer body portion. The outer body portion includes a first magnet ring or series of first magnets arranged on an inside surface of the outer body portion. The inner driven portion includes a second magnet ring or series of second magnets arranged on an outside surface of the driven inner portion facing the first magnet ring or series of first magnets. One end of the inner driven portion is operatively connected to a capping attachment that rotates with the inner driven portion. On its other end, the capping attachment is made to grip a bottle cap.

When the two sets of magnets are magnetically coupled, the magnets fixedly connect the outer body portion to the inner driven portion. An axial adjustment mechanism is additionally provided to adjust the degree of axial overlap between the first magnet ring, or series of first magnets, and the second magnet ring, or series of second magnets. Through this variable longitudinal overlap, the total attraction force of the magnets may be adjusted.

When the magnets are no longer magnetically coupled, the inner driven portion rotates around a hollow center shaft that is mounted to the outer body portion. During the capping process, a capping drive rod may be pushed through the center shaft and downward onto a bottle cap for urging the cap onto the bottle.

In the present invention, in order to reduce residual rotational inertia, the mass of the inner driven portion is reduced. Longitudinal cavities are formed or machined into the inner driven portion, radially inward from the second magnets. In addition, disk-shaped cavities are formed or machined into the inner driven portion.

Another improvement according to exemplary embodiments of the invention is to locate larger magnets on the inside of the outer body portion and locate the smaller, hysteresis magnets on the outside of the rotating, inner driven portion.

In addition, the inner driven portion is substantially composed of a lightweight material, such as aluminum. A thin sleeve over this lightweight material forms a surface on which the magnets are attached. Both by utilizing increased cavity or void volumes and by using lightweight material, the mass of the inner driven portion is reduced. This reduced mass of the inner driven portion reduces the residual rotational inertia exerting a torque on the bottle cap.

### BRIEF DESCRIPTION OF THE DRAWINGS

FIG. 1 is a perspective view of the magnetic clutch of the present invention;

FIG. 2 is a longitudinal sectional view of the magnetic clutch of the present invention;

FIG. 3 is a perspective view of the inner driven portion of the present invention;

FIG. 4 is a longitudinal sectional view of the inner driven portion of the present invention;

FIG. 5 is a longitudinal sectional view of another embodiment of the magnetic clutch of the present invention;

FIG. 6 is a perspective view of another embodiment of the inner driven portion of the present invention; and

FIG. 7 is a longitudinal sectional view of another embodiment of the inner driven portion of the present invention.

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

FIG. 1 shows the low inertia magnetic capping clutch 30 of the preferred embodiment of the present invention. At the top of low inertia clutch 30 is a drive attachment 31. Drive attachment 31 is the location at which the clutch connects to a powered, rotating mechanism (not shown).

Also shown is the outside of an outer body portion 32. At the bottom of low inertia clutch 30 is the bottom of an inner driven portion 34. From the inner driven portion, a knock out rod 35 is shown extending downward. The function of the knock out rod is to eject or knock out a cap if there is a bottle missing during the capping process.

FIG. 2 shows a cross section of low inertia clutch 30. Inner driven portion 34 is coupled to outer body portion 32 by means of inner magnet series 36, and outer magnet series 38. In the preferred embodiment, the outer magnet series 38 is axially movable to be in variable amounts of overlapped axial alignment with inner magnet series 36.

Radially inside inner magnet series 36 is magnet sleeve 40. Magnet sleeve 40 covers a magnet hub 42. Magnet hub 42 is preferably made of a light material, such as aluminum. Magnet sleeve 40 is a thin sleeve of a ferro-magnetic material, such as a steel sleeve, on which to mount inner magnet series 36.

Magnet hub 42 contains longitudinal cavities, 44, arranged in a circular pattern around a centerline of the hub. The provision of these cavities reduces the mass of the inner driven portion 34. The semi-hollow, quasi-cylindrical shape of the inner driven portion 34 causes the formation of disk-shaped cavities 46a, 46b. The presence of these cavities further reduces the mass of the inner driven portion 34. The inner driven portion 34 can be greater than 80% hollow (20% solid) by volume, and preferably 90% hollow (10% solid) by volume.

At the bottom end of inner driven portion 34 is a capping shaft 37. The capping shaft 37 is fixed to the magnet hub 40 by adhesive or by a press fit by other means. Capping shaft 37 can be composed of non corrosive stainless steel. A center shaft 50 is centered in capping shaft 37. A knock out rod 35, moves within the hollow interior of center shaft 50. Knock out rod 35 applies downward pressure on bottle caps to eject them if the bottles are missing so the chuck can pick up a new cap which will be attached by the capping machine.

Inner driven portion 34 rotates around center shaft 50 by means of ball bearing 52. Ball bearing 52 is fit between the sleeve 40 and the shaft 50. Another ball bearing 54 fits between the capping shaft 37 and a bottom wall 55 of outer body portion 32, to allow for reduced friction in the relative rotation between the portions 32, 34.

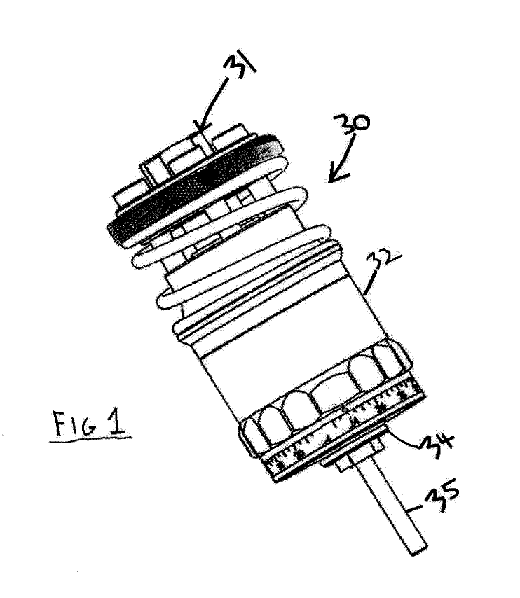

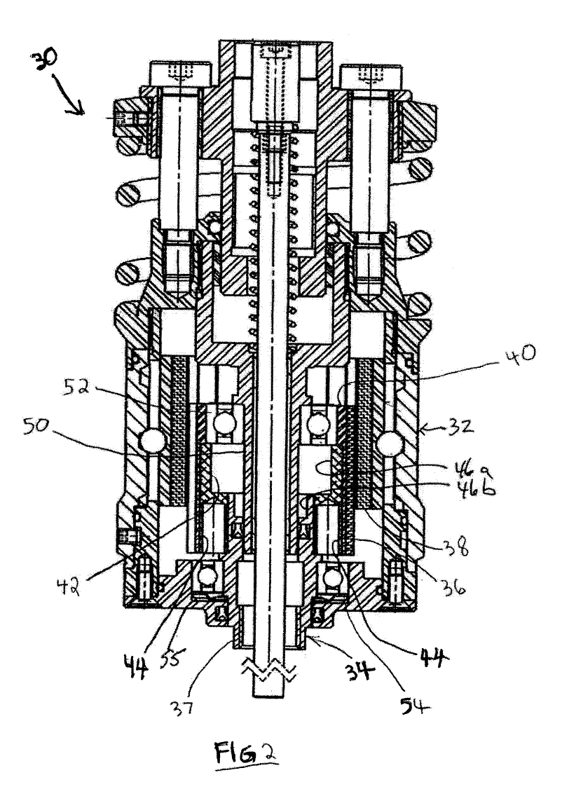

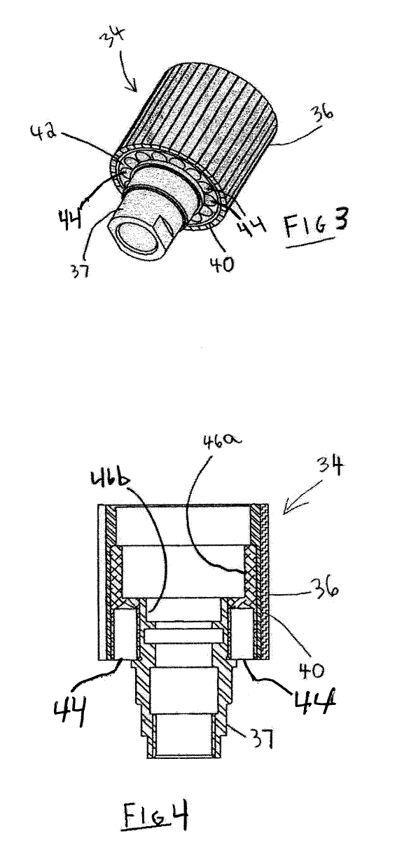

FIGS. 3 and 4 show the inner driven portion 34 removed from the rest of low inertia clutch 30. Inner magnet series 36 is shown located around the perimeter of inner driven portion 34. Magnet sleeve 40 is located just inside inner magnet series 36. On the inside of magnet sleeve 40 is the magnet hub 42. Magnet hub 42 contains longitudinal cavities 44 oriented in a circular pattern around the circumference of capping shaft 37. In the preferred embodiment, the shape of each of these cavities is cylindrical. In FIG. 4, the cavities 46a, 46b are also shown.

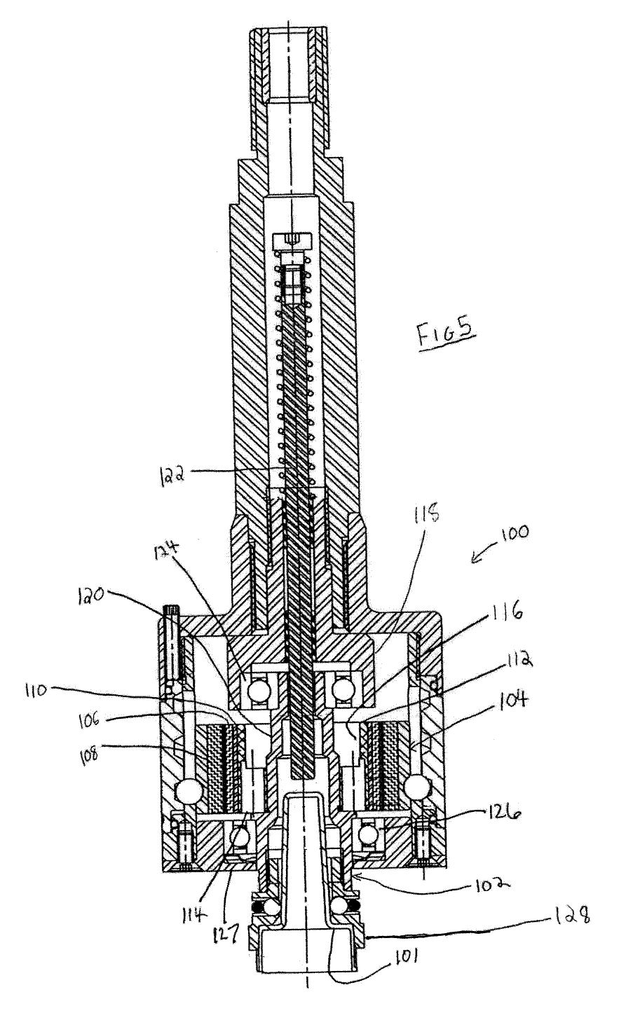

FIGS. 5 through 7 show another embodiment of the present invention. FIG. 5 shows a cross section of a low inertia clutch 100 engaged to a spout type bottle cap 101. As previously described, an inner driven portion 102 is driven by an outer body portion 104. Inner driven portion 102 may be coupled to outer body portion 104 by means of an inner magnet series 106 and an outer magnet series 108. The outer magnet series 108 is axially movable with respect to inner magnet series 106. A magnet sleeve 110 is located radially inside the inner magnet series 106. This magnet sleeve 110 is preferably a steel sleeve on which to mount the inner magnet series 106.

Inside magnet spacer 110 is the magnet hub 112. The magnet hub 112 is preferably made of a light material, such as aluminum. Magnet hub 112 contains longitudinal cavities 114. The provision of these cavities serves to reduce mass and rotational inertia of the inner driven portion 102. Disc-shaped cavity 116 is located near the upper end of inner driven portion 102. This further reduces the rotating inertia of the inner driven portion 102. The magnet hub 112 is fixed by adhesive or press fitting or other means to a capping shaft 120. The inner driven portion 102 can be greater than 80% hollow by volume, and preferably can be 90% hollow by volume.

In this embodiment, the capping shaft 120 extends all the way up into the outer body portion 104. In this way, a knock out rod 122 extends directly through capping shaft 120. A rotation dock 118 is shown at the top of capping shaft 120. Inner driven portion 102 rotates with respect to outer body portion 104 due to a ball bearing 124 located between capping shaft 120 and rotation dock 118. Another ball bearing 126 is located between capping shaft 120 and a bottom wall 127 of the outer body portion 104. Capping shaft 120 can be composed of non-corrosive stainless steel.

A capping attachment 128 is shown attached to the bottom of capping shaft 120. The attachment 128 includes a gripping mechanism to engage the cap 101. Capping attachment 128 is one of many different shapes and sizes of capping attachment usable with the clutch of the present invention.

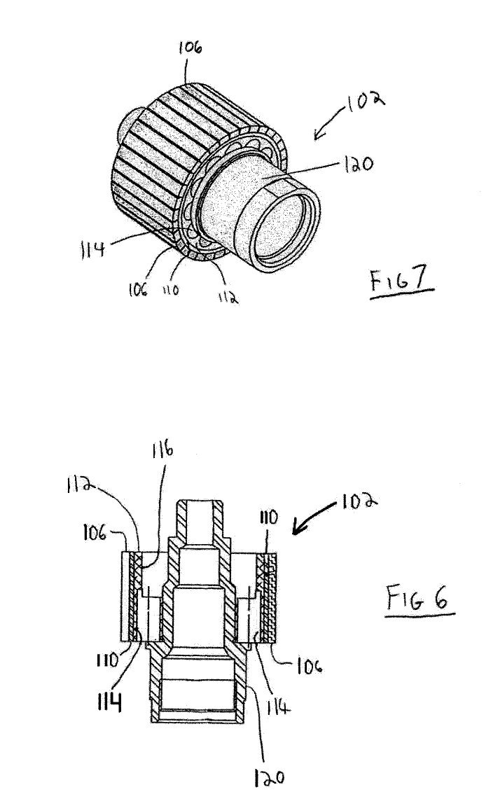

FIGS. 6 and 7 show the inner drive portion 102 removed from the rest of the low inertia clutch 100. Inner magnet series 106 is shown located around the perimeter of inner driven portion 102. Magnet spacer 110 is located just inside inner magnet series 106. On the inside of magnet spacer 110 is magnet hub 112. Magnet hub 112 contains longitudinal cavities 114 oriented in a circular pattern around the centerline of capping shaft 120. In the preferred embodiment, the shape of each of these cavities is cylindrical. Capping shaft 120 extends from below the magnet hub 112 through and beyond the length of the inner magnet series 106. In FIG. 6, cavity 116 is also shown.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A low inertia capping clutch comprising:
a clutch outer body portion to be rotated by a drive means;
a clutch inner driven portion to be driven by said outer body portion;
a coupling and releasing means for clutching,
wherein said driven portion is composed of a material having a density less than steel.

2. The low inertia capping clutch of claim 1, wherein said clutch inner driven portion comprises cavities for lowering a mass and inertia of said inner drive portion.

3. The low inertia capping clutch of claim 2, wherein said cavities comprise multiple cavities arranged in a circular pattern around a perimeter of said cap pressing means.

4. The low inertia capping clutch of claim 3, wherein said cavities are circularly cylindrical.

5. The low inertia capping clutch of claim 4, wherein said coupling and releasing means comprises two sets of magnets.

6. The low inertia capping clutch of claim 5, wherein said two sets of magnets are axially movable with respect to each other.

7. The low inertia capping clutch of claim 6, wherein said sets of magnets are movable by rotating an outer gauge on a body of the clutch.

8. The low inertia capping clutch according to claim 2, wherein said cavities comprises one or more spacious cavities located in and around a location of said cap pressing means.

9. The low inertia capping clutch of claim 8, wherein said coupling and releasing means comprises two sets of magnets.

10. The low inertia capping clutch of claim 9, wherein said two sets of magnets are axially movable with respect to each other.

11. The low inertia capping clutch of claim 10, wherein said sets of magnets are movable by rotating an outer gauge on a body of the clutch.

12. The low inertia capping clutch of claim 1, wherein said clutch inner driven portion is composed of aluminum.

13. The low inertia capping clutch of claim 12, wherein said materials used to form clutch inner driven portion comprises aluminum.

14. The low inertia capping clutch of claim 13, wherein said lightweight core has a ferro-magnetic sleeve wrapped therearound.

15. The low inertia capping clutch of claim 14, wherein said sleeve is composed of steel.

16. The low inertia capping clutch of claim 15, wherein said coupling and releasing means comprises two sets of magnets.

17. The low inertia capping clutch of claim 16, wherein said two sets of magnets are axially movable with respect to each other.

18. The low inertia capping clutch of claim 17, wherein said sets of magnets are movable by rotating an outer gauge on a body of the clutch.

19. A low inertia capping clutch comprising:
a clutch outer body portion to be rotated by a drive means;
a clutch inner driven portion to be driven by said outer body portion;
a coupling and releasing means for clutching; and
wherein said clutch inner driven portion comprises cavities for lowering a mass and inertia of said inner drive portion.

20. The low inertia capping clutch of claim 19, wherein said cavities comprise multiple cavities arranged in a circular pattern around a perimeter of said cap pressing means.

21. The low inertia capping clutch of claim 20, wherein said cavities are circularly cylindrical.
